(19) United States
(12) Patent Application Publication
(10) Pub. No.: US 2012/0319825 A1
(43) Pub. Date: Dec. 20, 2012

(54) METHODS, SYSTEMS, AND MEANS FOR RESTRICTING CONTROL OF A HOME ENTERTAINMENT DEVICE BY A MOBILE DEVICE

(75) Inventors: Camron Shimy, Canyon Country, CA (US); Michael R. Nichols, La Canada-Flintridge, CA (US); Thomas Steven Woods, Arlington Heights, IL (US); Daniel Thomas Ward, Los Angeles, CA (US); William J. Korbecki, Crystal Lake, IL (US); Glen E. Roe, Simi Valley, CA (US)

(73) Assignee: UNITED VIDEO PROPERTIES, INC., Santa Clara, CA (US)

(21) Appl. No.: 13/341,172

(22) Filed: Dec. 30, 2011

Related U.S. Application Data
(60) Provisional application No. 61/497,048, filed on Jun. 14, 2011.

(51) Int. Cl. G05B 11/01

(52) U.S. Cl. 340/12.5

(57) ABSTRACT

Methods and systems for restricting control of a home entertainment device by a mobile device are provided. In particular, in some embodiments, these methods and systems define a region for the mobile device. Then the methods and systems determine whether the mobile device is within a predetermined range of the region. In response to determining that the mobile device is within the predetermined range of the region, the methods and systems enable the mobile device to control a first function of the home entertainment equipment. In response to determining that the mobile device is outside of the predetermined range of the region, the methods and systems prevent the mobile device from controlling the first function of the home entertainment device and enable the mobile device to control a second function of the home entertainment device that is different from the first function.

### CROSS REFERENCE TO RELATED APPLICATION

This application claims the benefit of U.S. Provisional Patent Application No. 61/497,048, filed Jun. 14, 2011, which is hereby incorporated by reference herein in its entirety.

### BACKGROUND OF THE INVENTION

With the constant improvement in the capabilities of mobile devices (e.g., mobile computing devices, mobile communication device, etc.) and in the communication networks supporting such devices, interactivity between home user equipment devices on which programs can be presented and mobile user equipment devices which can control those home devices is increasing.

However, inadvertent use of a mobile device by a user away from the home can disrupt the user experience of users accessing the home device from within the home.

### SUMMARY OF THE INVENTION

In view of the foregoing, methods and systems for restricting control of a home entertainment device by a mobile device are provided. In particular, in some embodiments, these methods and systems define a region for the mobile device. Then the methods and systems determine whether the mobile device is within a predetermined range of the region. In response to determining that the mobile device is within the predetermined range of the region, the methods and systems enable the mobile device to control a first function of the home entertainment equipment. In response to determining that the mobile device is outside of the predetermined range of the region, the methods and systems prevent the mobile device from controlling the first function of the home entertainment device and enable the mobile device to control a second function of the home entertainment device that is different from the first function.

In some embodiments, the region may be defined as being within a certain distance from a specified location, or within a range of a given wireless communication network.

In some embodiments, the determination of whether the mobile device is within a predetermined range of the region is based on a GPS location determination for the mobile device, or based on the presence of a wireless link on a given wireless communication network. In some implementations, the determination of whether the mobile device is within a predetermined range of the region may be performed based on a combination of different techniques that indicate location of the mobile device. For example, the determination may be performed based on any combination of GPS location information, BlueTooth network information, WiFi network information (e.g., a signal strength of the WiFi signal to the base station), checking in to a social network, monitoring of a social network status update, or other long range or short range communication method.

In some embodiments, the preventing of the mobile device from controlling a first function includes disabling a mechanism for receiving a user command on the mobile device, not performing an operation requested in a message related to the first function from the mobile device at the home entertainment device, prompting a user at the home entertainment device whether a message related to the first function from the mobile device should be processed, prompting a user of the mobile device to confirm a command of the user to control the first function, or providing the user with an option to perform an alternate function instead of the first function. In some implementations, the home entertainment device may be prevented from performing a function on the mobile device (e.g., removing content stored on the mobile device) when the mobile device is outside of the predetermined range of the region.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments of the invention;

FIG. 3 shows an illustrative user equipment device in accordance with some embodiments of the invention;

FIGS. 4-5 are diagrams of illustrative cross-platform interactive media systems in accordance with some embodiments of the invention;

FIGS. 6-7 show illustrative user interfaces for setting up a Geo-Fence in accordance with some embodiments of the invention;

FIG. 8 is a diagram of a process for controlling commands of a mobile user equipment device based on its location in accordance with some embodiments of the invention;

FIG. 9 shows an illustrative user interface for providing a notification to a user and prompting the user for a response in accordance with some embodiments of the invention;

FIG. 10 is a diagram of a process for controlling setting, preferences, and profiles on a mobile user equipment device and a home user equipment device in accordance with some embodiments of the invention;

FIG. 11 is a diagram of a process for presenting notifications based on the location of a mobile user equipment device in accordance with some embodiments of the invention;

FIG. 12 shows an illustration of a user interface for selecting a home user equipment device from a mobile user equipment device in accordance with some embodiments of the invention;

FIG. 13 shows an illustrative user interface for setting up a rule in accordance with some embodiments of the invention;

FIG. 14 is an illustrative example of an XML structure for communicating a command and a location in accordance with some embodiments of the invention;

FIG. 15 is an illustrative example of an XML structure for communicating a device ID, a user ID, and a location in accordance with some embodiments of the invention;

FIG. 16 is an illustrative example of an XML structure for communicating a Geo-Fence definition in accordance with some embodiments of the invention; and

FIG. 17 is an illustrative example of an XML structure for communicating a rule definition in accordance with some embodiments of the invention.

### DETAILED DESCRIPTION OF EMBODIMENTS

The invention generally relates to methods and systems for restricting control of a home entertainment device by a mobile device are provided. In particular, in some embodiments, these methods and systems define a region for the mobile device. Then the methods and systems determine whether the mobile device is within a predetermined range of the region. In response to determining that the mobile device is within the predetermined range of the region, the methods and systems enable the mobile device to control a first function of the home entertainment equipment. In response to determining that the mobile device is outside of the predetermined range of the region, the methods and systems prevent the mobile device from controlling the first function of the home entertainment device and enable the mobile device to control a second function of the home entertainment device that is different from the first function.

In some embodiments, settings, preferences, and profiles can also be controlled based a location of a mobile device relative to a home user device.

In some embodiments, notifications can also be controlled based a location of a mobile device.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), duration/length information, mood information, genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

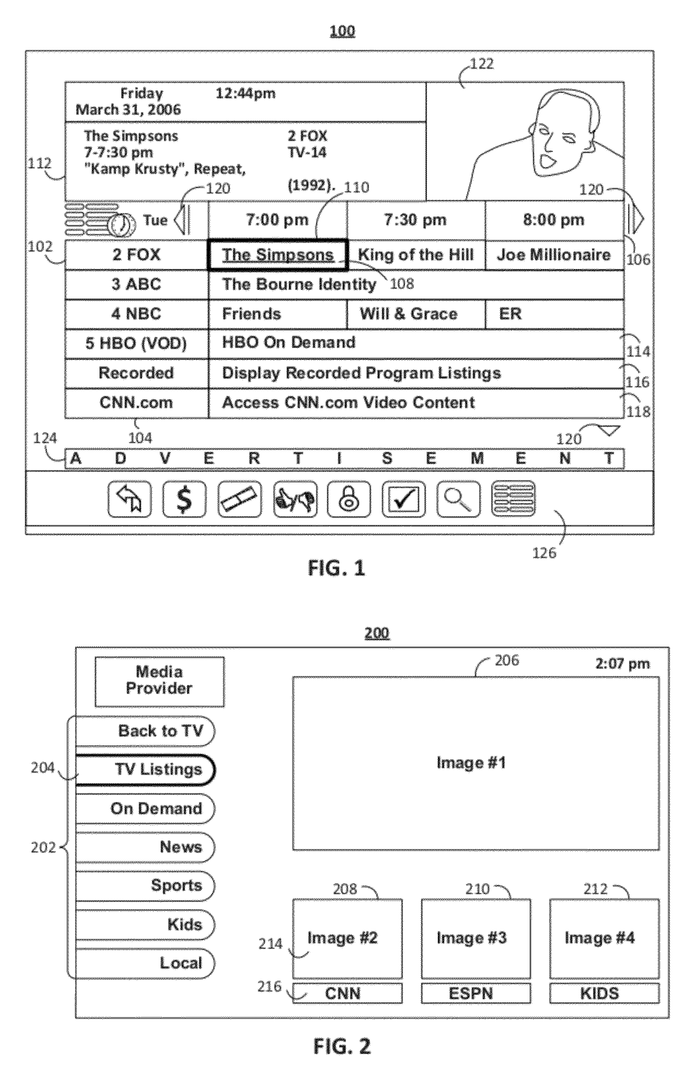

FIGS. 1-2 show illustrative display screens that may be used to provide media guidance data. The display screens shown in FIGS. 1-2, 6-7, 9, and 12-13 may be implemented on any suitable user equipment device or platform. While the displays of FIGS. 1-2, 6-7, 9, and 12-13 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or a guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

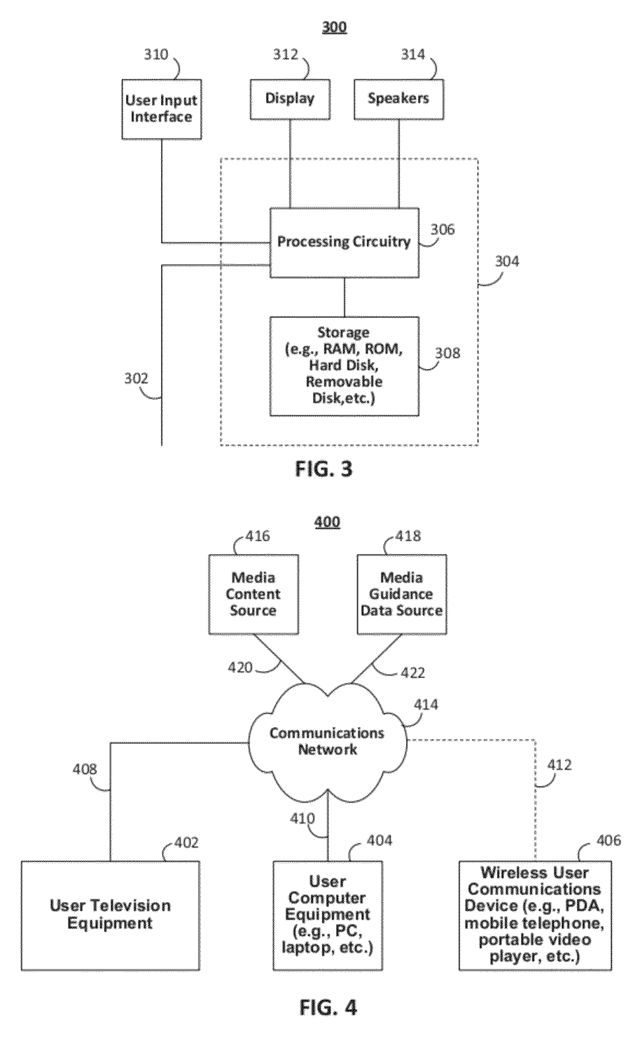

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or a supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized hardware processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using any other suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

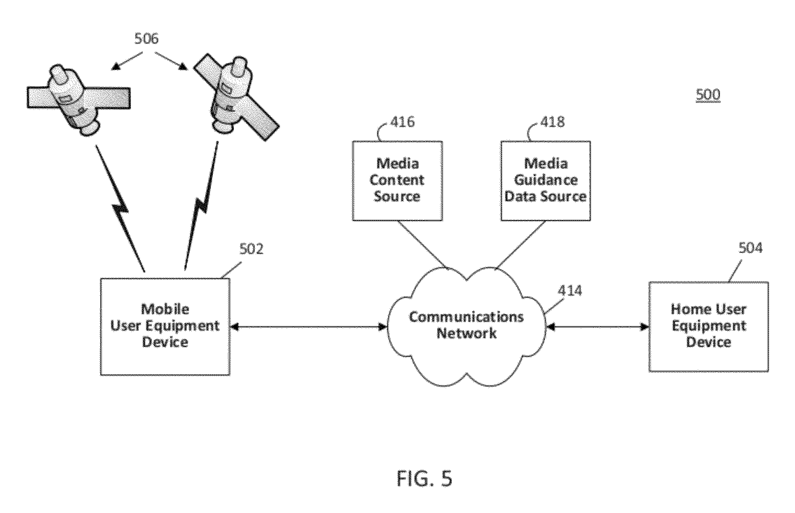

Turning to FIG. 5, an example of a more particular arrangement 500 of some of the components of FIG. 4 that may be implemented in some embodiments is illustrated. As shown, in some embodiments, arrangement 500 may include a mobile user equipment device (MUED) 502, a communication network 414, a media content source 416, a media guidance data source 418, and a home user equipment device (HUED) 504. MUED 502 may be implemented using any suitable user equipment device in some embodiments. For example, MUED 502 may be implemented using a wireless user communications device 406 (or a device similar to device 406), using a portable variation of user television equipment 402 or user computer equipment 404, etc. In some embodiments, MUED 502 may receive signals from any suitable mechanisms (e.g., such as global positioning system satellites 506, mobile telephone towers, wireless network transceivers, etc.) that facilitate the device determining its location (e.g., using triangulation).

MUED 502 or HUED 504 may include position information circuitry, such as Global Positioning System (GPS) circuitry, location-based services (LPS) circuitry, triangulation circuitry, hybrid positioning systems circuitry, or any other suitable position obtaining circuits or combinations of such circuits. MUED 502 or HUED 504 may use the position information obtained from the position information circuitry to determine the current position of MUED 502 or HUED 504. In some implementations, MUED 502 or HUED 504 may obtain the current position of MUED 502 or HUED 504 by accessing a social network, such as over the Internet. For example, MUED 502 or HUED 504 may monitor a status update posted to the social network for the user. MUED 502 or HUED 504 may parse the status update for information that identifies a current location of the user (e.g., name of a venue or event the user is attending). In some implementations, MUED 502 or HUED 504 may monitor a status update of a friend of the user on the social network. In particular, MUED 502 or HUED 504 may parse the status update of the friend of the user for information that identifies a particular location or event and the name of the user. In some implementations, MUED 502 or HUED 504 may obtain the current position of MUED 502 or HUED 504 by accessing a calendar associated with the user.

Communication network 414, media content source 416, and media guidance data source 418 may be as described above in connection with FIG. 4.

HUED 504 may be implemented using any suitable device or devices, such as user television equipment 402, user computer equipment 404, and wireless user communications device 406, in some embodiments.

Although only a single MUED and a single HUED are illustrated in FIG. 5, any suitable number of MUEDs and/or HUEDs may be provided in any suitable application. For example, a MUED may be provided for each person in a household. As another example, multiple HUED's may be located in different portions of a home.

While the terms home, house, household, home user equipment device, etc. are used herein for simplicity and clarity, these terms may apply to any suitable locations including homes and non-homes. For example, one or more HUEDs may be located in a restaurant or a bar, a store, an office, and/or any other suitable location in some embodiments.

As described further below, in some embodiments, various actions may be taken based on a location of a MUED 502 and/or based on a relative distance between a MUED 502 and a HUED 504. For example, in some embodiments, actions may be taken based on a MUED 502 being outside a defined area (e.g., an area in which a HUED 504 is located). In some embodiments, various actions may be prevented from being performed by MUED 502 or HUED 504 based on a location of a MUED 502 and/or based on a relative distance between a MUED 502 and a HUED 504. For example, in some embodiments, actions may be taken based on a MUED 502 being outside a defined area (e.g., an area in which a HUED 504 is located). This area may be referred to as a “Geo-Fence” in some embodiments.

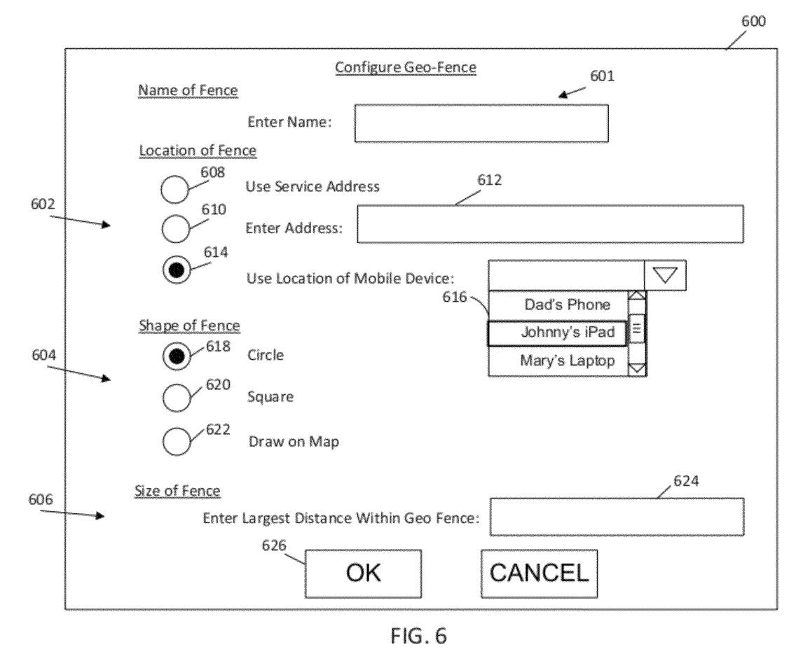

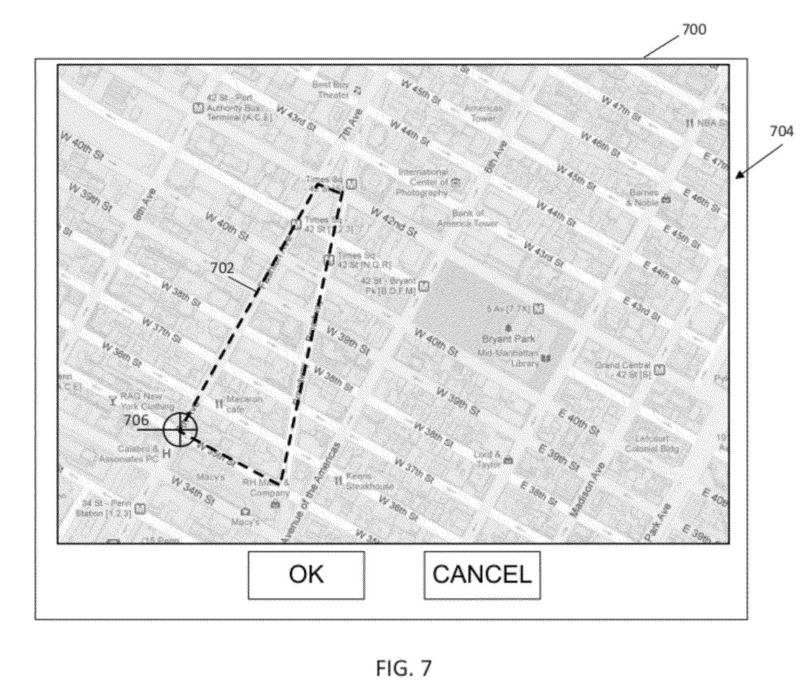

FIGS. 6 and 7 show examples of user interfaces 600 and 700, respectively, that may be presented by control circuitry 304 of a HUED 504 to define a Geo-Fence in some embodiments. As illustrated, a user may specify a name for a Geo-Fence in field 601, a location of the Geo-Fence (e.g., the center of a Geo-Fenced area) using region 602, a shape of the Geo-Fence using region 604, and a size of the Geo-Fence using region 606.

More particularly, in response to receiving user entry of a name in field 601 (e.g., using a user input interface of the HUED), control circuitry 304 may assign a name to the Geo-Fence.

In response to receiving a selection of one of radio buttons 608, 610, and 614, control circuitry 304 may configure the location of the Geo-Fence 504 based on the service address of the HUED (e.g., based on an identification number associated with the HUED), based on an address entered by the user in field 612, or based on the present location of a MUED selected from a menu 616, respectively. The service address of the HUED may be determined by the control circuitry based on information stored in the HUED's settings, and the location of a MUED may be determined by the control circuitry from location data received from the MUED via the communication network as described further below. Any other method for determining the location of the Geo-Fence may additionally or alternatively be used in some embodiments including those discussed above, such as accessing a social network status feed.

In response to receiving a selection of one of radio buttons 618, 620, and 622, control circuitry 304 may define the shape of the Geo-Fence as being a circle around the location of the fence, a square around the location of the fence, or a shape to be drawn on a map by the user (as described further below), respectively. Any other suitable shape and any other suitable mechanism for defining the shape may additionally or alternatively be used in some embodiments.

Finally, in field 624 of region 606, control circuitry 304 may receive a user's specification of the largest distance within the Geo-Fence. For example, if the Geo-Fence is specified in region 604 as being a circle, the user may specify in field 624 the diameter of the circle. As another example, if the Geo-Fence is specified in region 604 as being a square, the user may specify in field 624 a diagonal distance between two opposite corners of the square. As yet another example, if the Geo-Fence is specified in region 604 as to be drawn on a map, the user may specify the approximate scale of the Geo-Fence in field 624 so that an appropriately sized map may be presented for drawing the Geo-Fence. Any suitable distance may be specified in field 624 and the distance may be specified in any suitable units of measure. For example, in some embodiments, the distance may be 50 feet, 5 miles, two city blocks, 2 kilometers, etc. Any other suitable mechanism for specifying a size associate with the Geo-Fence may additionally or alternatively be used in some embodiments.

An example of such a map 704 for drawing a Geo-Fence 702 is illustrated in interface 700 of FIG. 7. This map may be presented by control circuitry 304 of the HUED upon it receiving a user selection of an OK button 626 after radio button 622 has been selected. Control circuitry 304 may initially display the map based on the location specified in region 602 and the size specified in region 606. Control circuitry 304 may then receive a user drawing of the Geo-Fence in response to: (i) the user moving a cross-hairs icon 706 to a first point on the map using arrow buttons on a user input interface 310; (ii) the user creating a corner of the fence using a single depression of an ENTER button on interface 310; (iii) the user moving icon 706 to a next corner location using the arrow buttons and creating the next corner and a fence portion between the next corner and the previous corner using the ENTER button; (iv) the user repeating (iii) any suitable number of times; and (v) the user creating a fence portion connecting the last corner back to the first corner using a double depression of an ENTER button on interface 310.

In some embodiments, a user may set up any suitable numbers (including none) of Geo-Fences, and/or any suitable numbers (including none) of Geo-Fences may be set up for the user.

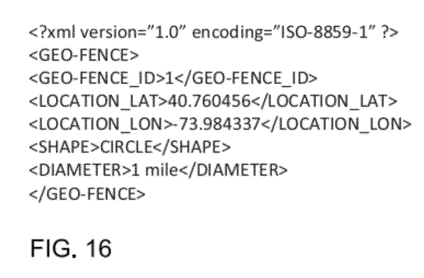

Once set up, each Geo-Fence can be saved to storage 308 of a HUED and/or MUED, to media guidance data source 418, and/or to any other suitable location. The Geo-Fence may be stored in any suitable manners, such as using an XML structure as illustrated in FIG. 16, in some embodiments.

In accordance with some embodiments, such a Geo-Fence may be used to control how commands entered at a MUED 502 are processed by the MUED and/or an associated HUED 504. For example, when a user would like to use a MUED 502 (e.g., the user's mobile phone) to control a presentation of content (e.g., a television program) by a HUED 504 (e.g., a set-top box and television), commands from the MUED may be treated differently based on whether the MUED is inside or outside of a Geo-Fence. More particularly, for example, a command from a MUED 502 to change a channel that is being presented on a HUED 504 may be ignored when the MUED is beyond a certain distance (e.g., as defined by a Geo-Fence) from the HUED.

As another example, in some embodiments, if a MUED is outside a Geo-Fence and a user of the MUED enters a command that would turn off content already being presented to other users, the MUED may: display an error message and not issue the command; display a warning with the option to either cancel or continue issuing the command; or provide an alternative suggestion instead of the given command (such as “You asked to tune to this channel, would you rather record instead?”).

As yet another example, in some embodiments, if a MUED is outside a Geo-Fence, certain user interface options in the MUED may be hidden or grayed-out.

As still another example, in some embodiments, if a MUED is outside a Geo-Fence and a user of the MUED enters a command that would turn off content already being presented to other users, the HUED may display a notification to any potential viewers within the household viewing environment with the option to disregard the command or allow the command to occur after a set time limit.

In accordance with some embodiments, such a Geo-Fence may be used to control how commands entered at a HUED 504 are processed by the MUED and/or an associated MUED 502. For example, when a user would like to use a HUED 502 (e.g., the user's home equipment) to delete content stored on the home equipment (e.g., a television program) or on a remote server (e.g., the cloud) and prevent all other equipments, such as MUED 502, associated with the user from accessing the content, commands from the HUED may be treated differently based on whether the MUED is inside or outside of a Geo-Fence. More particularly, for example, a command from a HUED 504 to delete the content accessible by all of the equipments associated with the user (e.g., delete content stored on the cloud) may be ignored by the MUED 502 and/or HUED 504 when the MUED is beyond a certain distance (e.g., as defined by a Geo-Fence) from the HUED.

As another example, in some embodiments, if a MUED is outside a Geo-Fence and a user of the HUED enters a command to delete content accessible by the HUED and MUED over the cloud, the HUED may: display an error message and not issue the command; display a warning with the option to either cancel or continue issuing the command; or provide an alternative suggestion instead of the given command (such as “You asked to delete this content from the cloud thereby preventing all of your devices from accessing the content, would you rather delete access to the content only for your television device and not your mobile phone?”).

In accordance with some embodiments, one or more rules may be used to define how a MUED 502 and a HUED 504 respond to a certain condition or a set of conditions, such as those described above. For example, one or more rules may be defined as having a condition and one or more actions as follows:

| Rule | Condition | MUED Action | HUED Action |
|---|---|---|---|
| 1 | MUED inside Geo-Fence | MUED | HUED operates |
| | | operates | normally |
| | | normally | |
| 2 | MUED outside Geo-Fence | Issue error | No action |
| | and command received | message to | |
| | that would alter | MUED user | |
| | current presentation | and ignore | |
| | | command | |
| 3 | MUED outside Geo-Fence | Warn MUED | Warn HUED |
| | and command received | user and | user and ask |
| | that would alter | ask whether | whether to |
| | current presentation | to continue | ignore |
| | | with | command |
| | | command | |
| 4 | MUED outside Geo-Fence | Ask MUED | Warn HUED |
| | and command received | user | user and ask |
| | to change to a program | whether to | whether to |
| | currently being | record the | ignore |
| | presented | program | command |
| | | instead | |
| 5 | MUED outside Geo-Fence | Inform MUED | Warn HUED |
| | and command received | of the | user and ask |
| | by HUED to delete | request | whether to |
| | content from the cloud | received by | implement |
| | (i.e., delete content | the HUED | command only |
| | from a storage | | on HUED and |
| | accessible to all of | | not MUED |
| | the equipments | | |
| | associated with the | | |
| | user) | | |
| 6 | MUED outside Geo-Fence | Gray-out | No action |
| | | certain | |
| | | MUED | |
| | | options so | |
| | | that | |
| | | commands | |
| | | cannot be | |
| | | entered | |
| 7 | MUED outside Geo-Fence | Hide | No action |
| | | certain | |
| | | MUED | |
| | | options so | |
| | | that | |
| | | commands | |
| | | cannot be | |
| | | entered | |

If the conditions are met, then the actions for the rule may be performed. Although particular examples of rules are shown, any suitable rules and any suitable numbers of rules may be used in some embodiments.

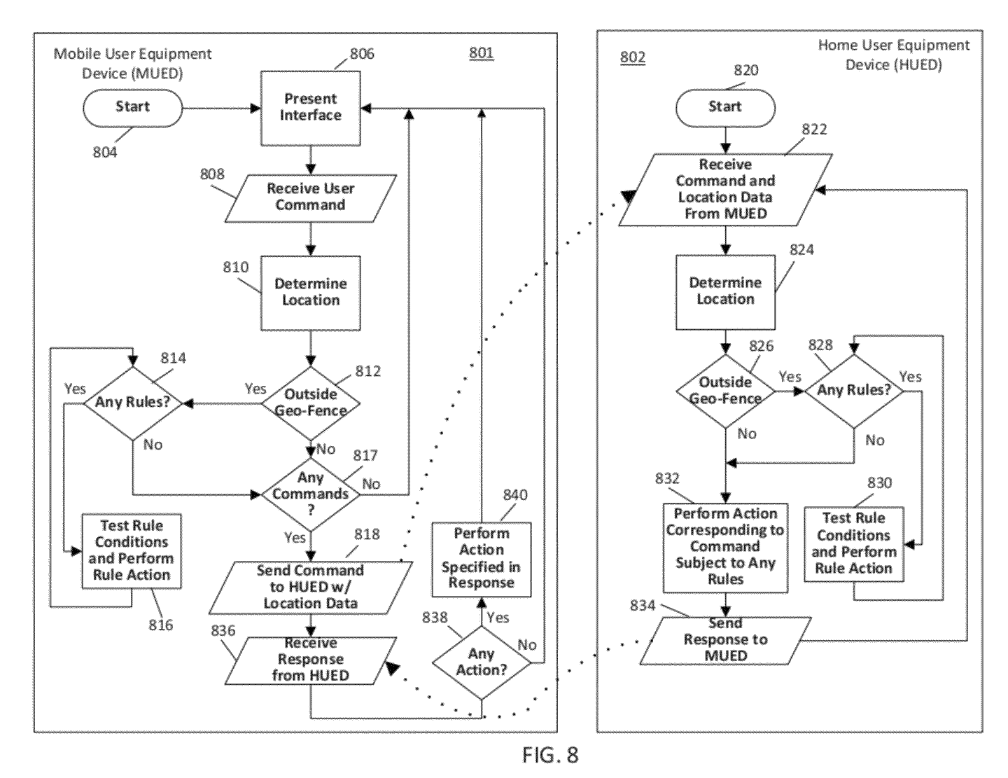

Turning to FIG. 8, examples of processes 801 and 802 that may be performed by control circuitry 304 of a MUED 502 and control circuitry 304 of a HUED 504, respectively, to implement such rules in accordance with some embodiments are shown.

As shown, after process 801 begins at 804, the MUED's control circuitry may present a user interface on a MUED 502 at 806. Any suitable user interface may be presented. For example, a user interface may be presented as illustrated in, and described in connection with, FIGS. 1 and 2. Next, at 808, the MUED's control circuitry may receive a user command at 808. Any suitable command may be received. For example, as shown in FIG. 1, a user may select to tune the HUED to “The Simpsons” by highlighting the corresponding program listing and pressing the ENTER button on a user input interface of the MUED. THE SIMPSONS is a trademark owned by Twentieth Century Fox Film Corporation.

At 810, the MUED's control circuitry may determine the location of the MUED. Determining the location of the MUED may be performed in any suitable manner discussed above and below. For example, the MUED's control circuitry may determine the MUED's location from global positioning system circuitry of the MUED.

The MUED's control circuitry may next determine at 812 whether the MUED is outside of a HUED's Geo-Fence. This determination may be made in any suitable manner. For example, this determination may be made by loading the Geo-Fence's data (e.g., in an XML structure as illustrated in FIG. 16) and determining whether the MUED's location is within the area defined by that data.

If it is determined that the MUED is outside of the Geo-Fence, then the MUED's control circuitry may determine at 814 whether there are any rules to process based on the command selected. If there are rules to process, the MUED's control circuitry may test the rule's condition(s) and, if satisfied, perform the rule action, at 816.

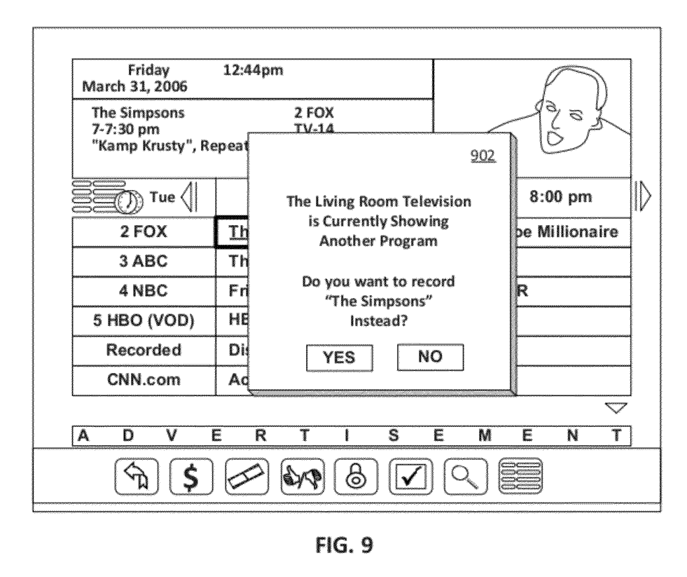

For example, in some embodiments, the MUED's control circuitry may determine that, because the MUED is outside of the Geo-Fence and a user of the HUED is currently watching another program on the HUED that the MUED user is attempting to control, a message should be presented to the MUED user indicating that the HUED user is watching another program and offering to record the program instead of tuning to the program. An example of such a message 902 is illustrated in FIG. 9 in accordance with some embodiments. The MUED's control circuitry may loop back to 814 to determine if there are any more rules to process.

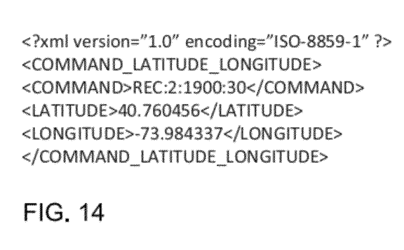

If it is determined at 812 that the MUED is not outside the Geo-Fence, or after processing all of the rules at 814 and 816, the MUED's control circuitry may proceed to 817 where it determines whether any command needs to be sent to the HUED. If not, the process may loop back to 806. Otherwise, it sends a command to the HUED with location data for the MUED at 818. This command and location data may be sent in any suitable manner, such as using an XML structure as illustrated in FIG. 14, in some embodiments. The command sent at 818 may be the same as or different from the command received at 808 based on the rule actions performed at 816 in some embodiments. For example, if a command to tune to a program is received at 808, the command may be changed to a command to record the program at 816 due to a corresponding rule, and this record command may be sent at 818.

After process 802 has begun at 820, the command and the location data sent at 818 may be received at 822 by the HUED's control circuitry 304. Next, at 824, the HUED's control circuitry may determine the location of the MUED based on the location data received at 822.

Next, control circuitry 304 of the HUED may then determine at 826 whether the MUED is outside the HUED's Geo-Fence. This determination may be performed in any suitable manner. For example, this determination may be made by loading the Geo-Fence's data (e.g., in an XML structure as illustrated in FIG. 16) and determining whether the MUED's location is within the area defined by that data.

If it is determined that the MUED is outside of the Geo-Fence, then the HUED's control circuitry may determine at 828 whether there are any rules to process based on the command received. If there are rules to process, the HUED's control circuitry may test the rule condition(s) and, if satisfied, perform the rule action, at 830.

For example, in some embodiments, the HUED's control circuitry may determine that, because the MUED is outside of the Geo-Fence and a user of the HUED is currently watching another program on the HUED that the MUED user is attempting to control, a message should be presented to the HUED user indicating that the MUED user is attempting to change the channel and asking whether to ignore the MUED user's command.

The HUED's control circuitry may then loop back to 828 to determine if there are any more rules to process.

If it is determined at 826 that the MUED is not outside the Geo-Fence, or after processing all of the rules at 828 and 830, the HUED's control circuitry may proceed to 832 where it performs the action corresponding to the command subject to any rule actions performed at 830. For example, if the command received specifies to change channels if no user at the HUED objects, and an objection is received, the command may be ignored at 832. As another example, if the command received specifies to change channels if no user at the HUED objects, and no objection is received, the command may be performed at 832.

Next, the HUED's control circuitry may send a response to the command to the MUED at 834, and then loop back to 822 to wait for the next command.

Any suitable response may be sent. For example, in some embodiments, a response may be sent indicating that the command was completed. As another example, in some embodiments, a response may be sent indicating that the command was ignored. As yet another example, in some embodiments, a response may be sent indicating that a message should be presented to the user.

The response sent at 834 may then be received by the MUED's control circuitry at 836. The MUED's control circuitry may next determine at 838 whether any action needs to be taken in response to the response received at 836, and, if so, perform that action at 840. If it is determined at 838 that no action is to be performed, or after performing the action at 840, process 801 may loop back to 806.

In some embodiments, one or more processes may be performed by control circuitry 304 of the MUED and control circuitry 304 of the HUED that periodically check the conditions for rules not requiring a command to be received and performing the rule action(s) if the conditions have been met.

Although only a single instance of process 801 and a single instance of process 802 are illustrated in FIG. 8, any suitable number of each of these processes may be implemented in some embodiments. For example, multiple instances of process 801 may be implemented on a MUED 502. As another example, multiple instances of a process 802 may be implemented on a HUED 504.

It should be understood that some of the above steps of the flow diagram of FIG. 8 may be executed or performed in an order or sequence other than the order and sequence shown and described in the figure. Also, some of the above steps of the flow diagram of FIG. 8 may be executed or performed substantially simultaneously where appropriate or in parallel to reduce latency and processing times.

Additionally or alternatively to providing mechanisms for controlling how commands are processed based on the location of a MUED, in accordance with some embodiments mechanisms may be provided for controlling settings, preferences, profiles, etc. of a MUED and a HUED based on a location of the MUED. For example, in some embodiments, a MUED may determine which of multiple HUEDs is closest to the MUED, and configure its settings to match the settings of the closest HUED. As another example, in some embodiments, a HUED may determine which of multiple MUEDs is closest to the HUED, and configure its preferences to match the preferences of the closed MUED. As yet another example, in some embodiments, the amount of data provided to a MUED, or the frequency with which a MUED's data is updated, may be controlled based on the location of the MUED relative to a HUED.

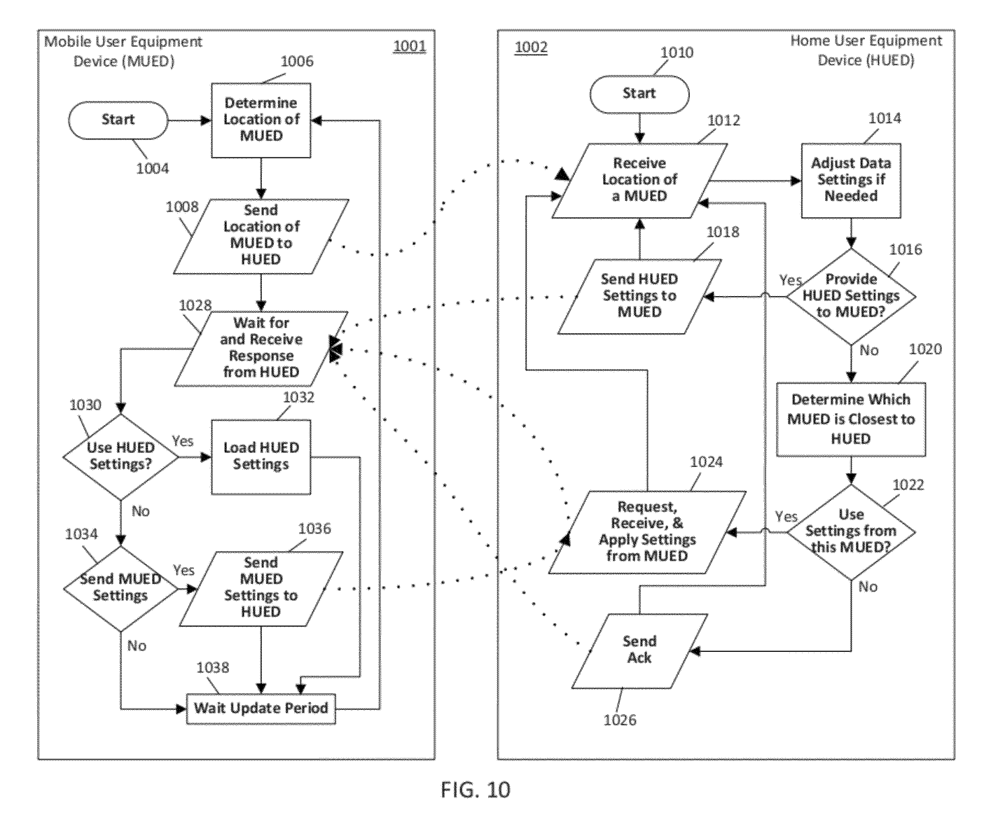

FIG. 10 illustrates examples of processes 1001 and 1002 for controlling settings, preferences, profiles, and/or any other suitable configuration data (hereinafter collectively, “the configuration”) that may be performed by control circuitry 304 of MUED 502 and control circuitry 304 of HUED 504 in accordance with some embodiments.

As shown, after process 1001 begins at 1004, the MUED's control circuitry may determine the location of the MUED at 1006. Any suitable mechanism for determining the location of the MUED may be used in some embodiments. For example, the control circuitry may determine the location of the MUED based on information received from global positioning system circuitry.

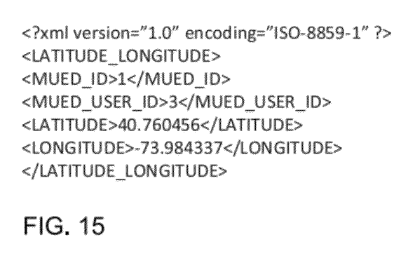

Next, at 1008, the MUED's control circuitry may send location data for the MUED to the HUED. This location data may be sent in any suitable manner. For example, in some embodiments, this location data may be sent in an XML structure as illustrated in FIG. 15.

After process 1002 begins at 1010, the HUED's control circuitry may receive the location of the MUED at 1012.

Next, at 1014, the HUED's control circuitry may adjust data settings if needed. Any suitable data settings may be adjusted in some embodiments, and the data settings may be adjusted for any suitable reason. For example, data usage on a network may be modified to transmit more or less data and/or to change the frequency with which data is transmitted. As a more particular example, if the MUED is outside a Geo-Fence around a user's home, the data provided to the MUED may be prioritized and/or decreased in order to prioritize and/or decrease bandwidth usage on public networks.

The HUED's control circuitry may next determine at 1016 whether to provide the HUED's configuration to the MUED. This determination may be made on any suitable basis in some embodiments. For example, in some embodiments, this determination may be made so that the HUED's configuration is to be provided to the MUED when the MUED enters a Geo-Fence area. If is determined at 1016 that the configuration is to be provided, then at 1018 the HUED's configuration may be sent by the HUED's control circuitry to the MUED.

However, if it is determined that the HUED's configuration is not to be provided to the MUED, then the HUED's control circuitry may determine which MUED is closest to the HUED at 1020. This determination may be made in any suitable manner. Then at 1022, the HUED's control circuitry may determine whether to use the configuration from a given MUED. This determination may be made on any suitable basis. For example, this determination may be made based on which MUED is the closest, based on whether any MUED has priority over other MUED(s), and/or based on any other suitable criteria or criterion. If configuration from a MUED is to be used, then the HUED's control circuitry may request, receive, and apply the configuration from the MUED at 1024. Otherwise, the HUED's control circuitry may send an acknowledgement message at 1026 to acknowledge receipt of the location data sent at 1008. After sending the HUED's configuration at 1008, applying the MUED's configuration at 1024, or sending an acknowledgement message at 1026, process 1002 may loop back to 1012.

Returning to process 1001, at 1028, the MUED's control circuitry may wait for and receive a response from the HUED (like generated at 1018, 1024, and 1026 as described above). Next, at 1030, the MUED's control circuitry may determine whether to use the HUED's configuration. The determination may be made on any suitable basis. For example, in some embodiments, the MUED may determine to use the HUEDs configuration when the MUED is within a Geo-Fence around the HUED. If it is determined that the MUED is to use the HUED's configuration, the HUED's control circuitry may load the HUED's configuration at 1032.

If it is determined at 1030 that the MUED is to not use the HUED's configuration, the MUED's control circuitry may determine at 1034 if the MUED's configuration is to be sent to the HUED. This determination may be made on any suitable basis. For example, the MUED may determine that its configuration is to be sent to the HUED if the HUED requested that configuration in a message sent at 1024 and received at 1028. If it is determined at 1034 that the MUED's configuration is to be sent to the HUED, then the MUED's control circuitry may send the MUED's configuration to the HUED at 1036.

After loading the HUED's configuration, after sending the MUED's configuration to the HUED, or after determining that the MUED's configuration is not to be sent to the HUED, the MUED's control circuitry may wait for any suitable update period (including none) at 1038 and then loop back to 1006.

Although only a single instance of process 1001 and a single instance of process 1002 are illustrated in FIG. 10, any suitable number of each of these processes may be implemented in some embodiments. For example, multiple instances of process 1001 may be implemented on a MUED 502. As another example, multiple instances of a process 1002 may be implemented on a HUED 504.

It should be understood that some of the above steps of the flow diagram of FIG. 10 may be executed or performed in an order or sequence other than the order and sequence shown and described in the figure. Also, some of the above steps of the flow diagram of FIG. 10 may be executed or performed substantially simultaneously where appropriate or in parallel to reduce latency and processing times.

In accordance with some embodiments, other actions relating to content may additionally or alternatively be taken at a MUED or a HUED based upon the location of the MUED.

For example, in some embodiments, one or more notifications to take action on a time sensitive task may be provided to the user of the MUED based on a prediction that the user will not be able to act on the task from the HUED based on the current location of MUED (e.g., outside a certain wide area Geo-Fence, such as a fifty mile diameter fence around a HUED). More particularly, for example, a notification may be presented to the user via the MUED that indicates that certain content has been saved on the HUED, that this content has not been watched, and that this content is about to be overwritten. This notification may also enable the user to review the content and designate one or more of the content as to be saved.

As another example, in some embodiments, based on the MUED being determined to be at a certain location (such as a tourist destination or any other suitable location), one or more pieces of content related to the place the user is visiting may automatically be recorded or scheduled to be recorded on a HUED. More particularly, for example, based on the MUED being determined to be at the Grand Canyon, content on the Colorado River may automatically be recorded on the HUED.

As yet another example, in some embodiments, based on it being determined that the MUED is repeatedly at a certain store, an advertisement for that store may be scheduled to appear on the HUED. As a more detailed example, in some embodiments, a message reflecting that an advertisement has been presented or scheduled to be presented may also be sent from the HUED to a billing system so that a credit for viewing the advertisement may be applied.

As still another example, in some embodiments, based on the MUED being determined as likely to pass one or more businesses, advertisements for the one or more businesses may be presented to the user on the MUED or the HUED. More particularly, for example, if it is determined that a MUED has repeatedly passed a certain business after being in its present location, or if it is determined that the only path between a present location of the MUED and the HUED passes the business, then an advertisement for the business may be presented on the MUED.

As still another example, in some embodiments, based on a MUED associated with a particular user being away from the HUED, a prediction that one or more users locally accessing the HUED are not the particular user may be made and statistics gathered based on that prediction. More particularly, for example, if a husband and a wife live in the same house with no one else, the wife leaves for work while carrying her MUED, and the husband watches television using a HUED before going to work, it may be determined that the husband is watching television and statistics regarding his viewing habits may be gathered.

As still another example, in some embodiments, based on all MUEDs associated with the users in a particular home being away from a HUED (e.g., outside a one-quarter mile Geo-Fence) and detecting that the HUED is currently ON, a notification can be presented on one or more of the MUEDs indicating that the HUED is ON.

In some embodiments, data from content and/or content listings may be used in a rule. For example, in some embodiments, data detailing celebrities within a scene, data detailing a designer of an outfit for a celebrity in a scene, data detailing a location at which a scene was shot, data detailing a song being played within a scene, data detailing a celebrity who wrote a song being played, and/or any other suitable data may be used in a rule. As a more particular example, based on a MUED being located at or near a scene location from a movie currently available or about to be available, a HUED may automatically record the movie and alert the user that the movie is being recorded.

As another example, in some embodiments, based on a MUED being away from a HUED, based on a reminder for content being set, and based on a presentation of the content being imminent, a notification indicating that the content is about to be presented and that it may be accessed on a certain channel based on content listings related to the location of the MUED may be presented. In a more particular example, the MUED and/or the HUED may additionally or alternatively cause another user equipment device at the location of the MUED (e.g., in the user's hotel room) to present such a notification by sending a suitable request to this other device. In another more particular example, the MUED and/or the HUED may additionally or alternatively cause another user equipment device at the location of the MUED (e.g., in the user's hotel room) to present the content by sending a suitable request to this other device.

In some embodiments, data from a user profile, preferences, and/or any other suitable user data may be used in a rule. As a more particular example, based on a user preference indicating that a user likes certain content or types of content and based on a MUED being located in an area where that content or type of content is available, a notification to the user that the content or the type of content is available may be presented.

In accordance with some embodiments, one or more rules may be used to define how a MUED 502 and a HUED 504 respond to a certain condition or a set of conditions.

| Rule | Condition | Action |
|---|---|---|
| 1 | Content on HUED about to | Prompt to save |
| | be deleted | |
| 2 | MUED at location | Prompt to record |
| | corresponding to | content at HUED |
| | available content | |
| 3 | MUED is at a business of | Schedule |
| | an advertiser | advertisement for |
| | | presentation upon |
| | | the HUED when MUED |
| | | is at home and |
| | | notify billing |
| | | system of |
| | | advertisement |
| 4 | MUED is at repeat | Present |
| | location | advertisement on |
| | | MUED for business |
| | | between repeat |
| | | location and HUED |
| 5 | MUED of one user is away | Associate activity |
| | while MUED(s) of one or | on HUED with user(s) |
| | more others at home | whose MUED(s) is/are |
| | | home |
| 6 | Reminder set for content | Generate message on |
| | and MUED of a user is | MUED or other device |
| | away from home | locally available to |
| | | user indicating how |
| | | to watch content |
| | | based on local |
| | | content guide data |
| 7 | Recommendation settings | Generate message on |
| | set for content and/or | MUED or other device |
| | content type and MUED of | locally available to |
| | a user is away from home | user indicating how |
| | | to watch content or |
| | | content type based |
| | | on local content |
| | | guide data |

If the conditions are met, then the actions for the rule may be performed. Although particular examples of rules are shown, any suitable rules and any suitable numbers of rules may be used in some embodiments.

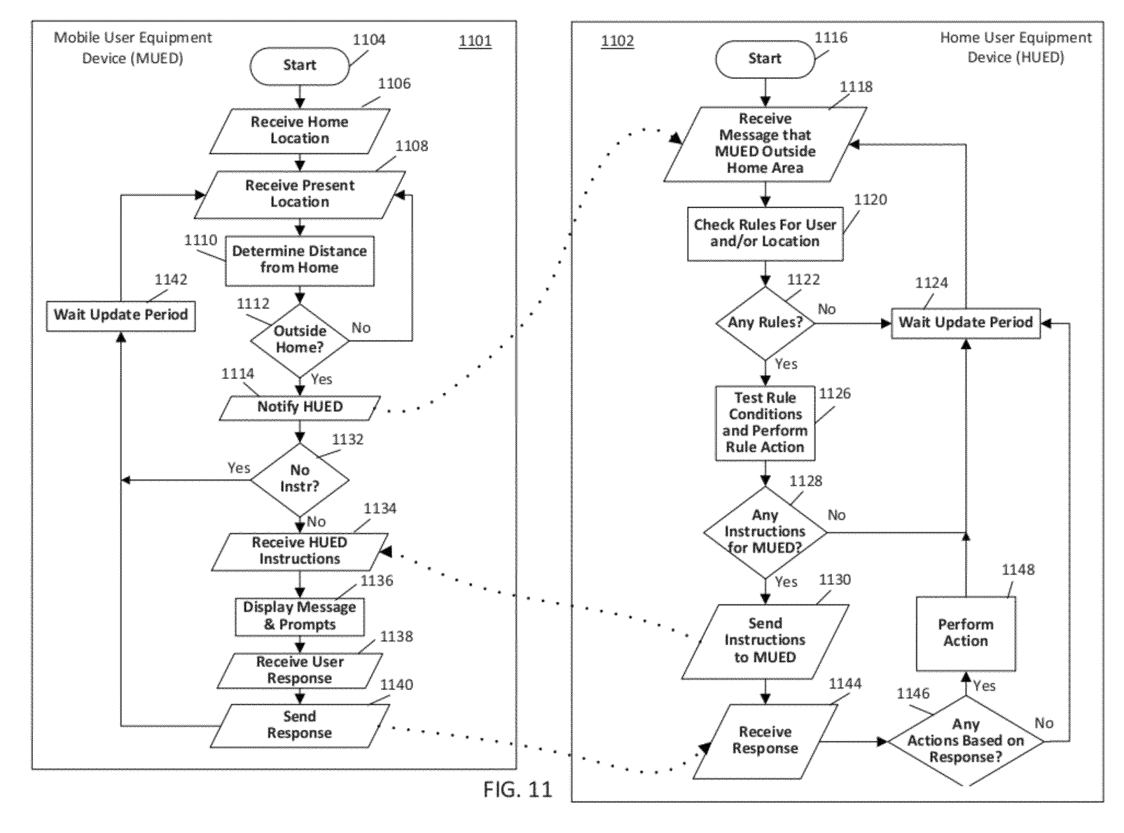

Examples 1101 and 1102 of processes for presenting notifications relating to content that may be performed in control circuitry 304 of MUED 502 and control circuitry 504, respectively, in accordance with some embodiments are shown in FIG. 11.

As illustrated, after process 1101 begins at 1104, the MUED's control circuitry may receive home location information at 1106. This home location information may be received in any suitable manner. For example, in some embodiments, this information may be received from settings or a profile stored in the MUED. Next, at 1108, the MUED's control circuitry may receive present location data. This data may be received in any suitable manner. For example, this data may be received from global positioning system circuitry in the MUED. The distance between the present location of the MUED and the home location may then be determined by the MUED's control circuitry at 1110, and this circuitry may determine if the MUED is outside of a home location at 1112. The determination of whether the MUED is outside of a home location may be made in any suitable manner. For example, in some embodiments, the determination may be based on a the distance determined at 1110, based upon a Geo-Fence set up as described herein, or based on any other suitable criteria or criterion. If the MUED is determined to not be outside of a home location at 1112, then process 1101 may loop back to 1108.

Otherwise, if the MUED's control circuitry determines that the MUED is outside of a home location, the MUED's control circuitry may notify the HUED at 1114. Any suitable mechanism for notifying the HUED may be used in some embodiments. For example in some embodiments, an XML structure as illustrated in FIG. 15 can be sent to the HUED.

As shown in process 1102, after the process begins at 1116, the HUED's control circuitry may receive the notification that the MUED is outside the home location at 1118. In some embodiments, this message may include a location for the MUED, an identifier of the MUED, a user of the MUED, and/or any other suitable data.

Next, at 1120, the HUED's control circuitry may check for rules for the user, the MUED, and/or the location. Any suitable rules may be used in some embodiments. For example, the rules may be configured as illustrated in the table above.

At 1122, the HUED's control circuitry may determine if any rules apply. If it is determined that no rules apply, then the HUED's control circuitry may wait for an update period (which can have any suitable duration, including no duration) to pass at 1124 and then loop back to 1118. Otherwise, the HUED's control circuitry may test rule conditions and perform the rule actions if those conditions have been met at 1126.

For example, as illustrated in rule 1 in the table above, if the HUED's control circuitry determines that content on the HUED is about to be deleted, the control circuitry can prepare a prompt to alert the user to this condition and ask whether the program should be saved.

The HUED's control circuitry may then determine at 1128 whether any instructions need to be sent to the MUED. Instruction may need to be sent to the MUED, for example, to cause a message to be presented to a user and to cause a response to the message to be collected and provided to the HUED. If no instructions need to be sent to the MUED, then process 1102 may branch to 1124. Otherwise, the HUED's control circuitry may send the needed instructions to the MUED at 1130.

Returning to process 1101, the MUED's control circuitry may determine whether no instructions are going to be received at 1132. Any suitable method for determining whether no instructions are going to be received may be used in some embodiments. For example, this determination may be made by waiting a specified period of time and if no instructions are received, determining that no instructions will be received.

If instructions are received, then the MUED's control circuitry may receive the MUED instructions at 1134. Next, based on these instructions, the MUED's control circuitry may display a message and prompt the user to enter a response. Any suitable message and any suitable prompt may be presented to the user. For example, in the example above, the message may state that content is about to be deleted, and the prompt may ask whether the content should be saved.

At 1138, a response to the prompt may be received from the user by the MUED's control circuitry. Any suitable response may be received in some embodiments. For example, in the example above, this response may indicate “Yes” or “No” to indicate whether to save the content or allow it to be deleted.

This response may then be sent by the MUED's control circuitry to the HUED at 1140. The MUED's control circuitry may then wait for the update period at 1142 and then loop back to 1108.

The response sent by the MUED at 1140 may then be received by the HUED control circuitry at 1144. Next, this control circuitry may determine whether any actions are to be performed based on the response. For example, in the example above, if the user indicated to save the content, then the content can be flagged by the control circuitry to be save. If it is determined at 1146 that an action is to be performed, then the action may be completed at 1148. Once the action is done, or after determining that no action is to be performed, then process 1102 may branch to 1124.

Although only a single instance of process 1101 and a single instance of process 1102 are illustrated in FIG. 11, any suitable number of each of these processes may be implemented in some embodiments. For example, multiple instances of process 1101 may be implemented on a MUED 502. As another example, multiple instances of a process 1102 may be implemented on a HUED 504.

It should be understood that some of the above steps of the flow diagram of FIG. 11 may be executed or performed in an order or sequence other than the order and sequence shown and described in the figure. Also, some of the above steps of the flow diagram of FIG. 11 may be executed or performed substantially simultaneously where appropriate or in parallel to reduce latency and processing times.

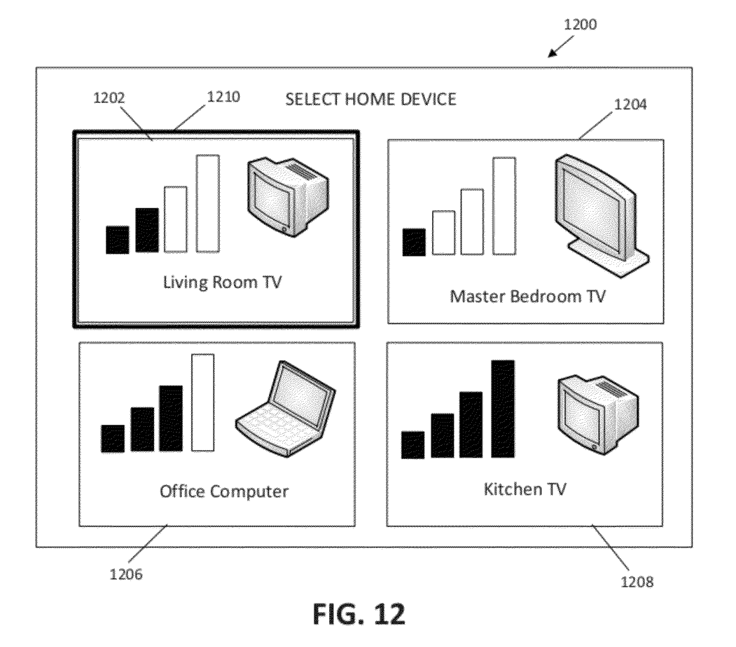

In accordance with some embodiments, a user interface may be presented on a MUED by its control circuitry to allow a user of the MUED to select one of multiple HUEDs upon which to issue a command, configure a rule, etc. An example 1200 of such an interface is shown in FIG. 12. As illustrated, multiple HUEDs 1202, 1204, 1206, and 1208 can be indicated. Although four HUEDs are shown, any suitable number of HUEDs can be identified in such an interface in some embodiments. Each HUED can be identified by a name, an icon, a proximity indicator, and/or by any other suitable indicator in some embodiments. The name and the icon can be configured in any suitable manner such as through a HUED setting that is set up on the HUED and communicated to the MUED from time to time or upon demand. The proximity indicator can show a bar graph indicating that with more full bars when the MUED is closer to a corresponding HUED. Additionally or alternatively to a bar graph for a proximity indicator, any other suitable proximity indicator, such as varying relative sizes for the HUED icons (e.g., larger is closer), varying audio indicators for the HUEDs (e.g., louder is closer), etc. can be used in some embodiments. In order to select a HUED, control circuitry 304 of the MUED may receive a user selection of a HUED (as indicated by highlight 1210) via a user input interface 310 of the MUED.

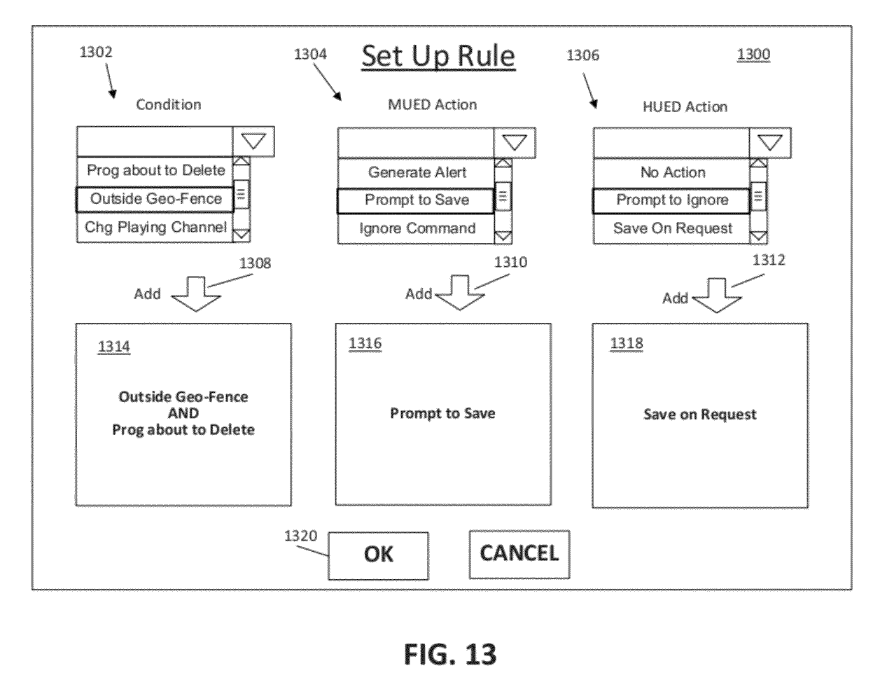

Turning to FIG. 13, an example of a user interface 1300 that may be presented by control circuitry 304 of a MUED 502 or by control circuitry 304 of a HUED 504 to set up a rule in accordance with some embodiments is shown. As illustrated, to set up a rule, the control circuitry may receive from a user a selection of a condition from menu 1302. Any suitable condition options may be provided and any suitable number of conditions may be available. Upon receiving a condition selection and a selection of an ADD icon 1308, the condition may be added by the control circuitry to space 1314. Upon a second (or further) selection of a condition and a selection of ADD icon 1308, one or more additional conditions can be added to space 1314 for the rule.

Next, control circuitry can receive a selection of an action (if any) to be performed at the MUED when the conditions are met. Similarly to the selection of a condition, an action at the MUED can be selected using menu 1304 and icon 1310 so that one or more actions are listed in space 1316. Any suitable actions, any suitable number of actions, and any suitable order of actions can be specified for the MUED in some embodiments.

Next, control circuitry can receive a selection of an action (if any) to be performed at the HUED when the conditions are met. Similarly to the selection of a condition, an action at the HUED can be selected using menu 1306 and icon 1312 so that one or more actions are listed in space 1318. Any suitable actions, any suitable number of actions, and any suitable order of actions can be specified for the MUED in some embodiments.

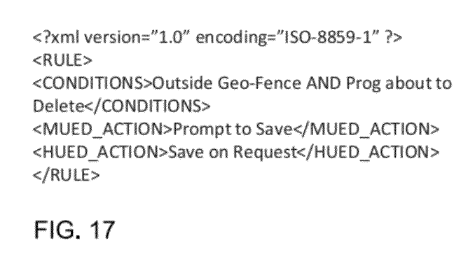

Finally, when a user is done adding a rule, the user can select an OK button 1320 and in response thereto the control circuitry may save the rule in an XML structure such as that illustrated in FIG. 17 in some embodiments.

In some embodiments, any suitable computer readable media may be used for storing instructions for performing the processes described herein. For example, in some embodiments, computer readable media may be transitory or non-transitory. For example, non-transitory computer readable media may include media such as magnetic media (such as hard disks, floppy disks, etc.), optical media (such as compact discs, digital video discs, BLU-RAY discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media may include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A method for restricting control of a home entertainment device by a mobile device, the method comprising:
defining a region for the mobile device;
determining whether the mobile device is within a predetermined range of the region;
in response to determining that the mobile device is within the predetermined range of the region, enabling the mobile device to control a first function of the home entertainment equipment; and
in response to determining that the mobile device is outside of the predetermined range of the region, preventing the mobile device from controlling the first function of the home entertainment device and enabling the mobile device to control a second function of the home entertainment device that is different from the first function.

2. The method of claim 1, wherein the region is within a certain distance from a specified location.

3. The method of claim 1, wherein the region is within a range of a given wireless communication network.

4. The method of claim 1, wherein the determining is based on a GPS location determination for the mobile device.

5. The method of claim 1, wherein the determining is based on the presence of a wireless link on a given wireless communication network.

6. The method of claim 1, wherein preventing the mobile device from controlling a first function comprises disabling a mechanism for receiving a user command on the mobile device.

7. The method of claim 1, wherein preventing the mobile device from controlling a first function comprises not performing an operation requested in a message related to the first function from the mobile device at the home entertainment device.

8. The method of claim 1, wherein preventing the mobile device from controlling a first function comprises prompting a user at the home entertainment device whether a message related to the first function from the mobile device should be processed.

9. The method of claim 1, wherein preventing the mobile device from controlling a first function comprises prompting a user of the mobile device to confirm a command of the user to control the first function.

10. The method of claim 1, wherein preventing the mobile device from controlling a first function comprises providing the user with an option to perform an alternate function instead of the first function.

11. A system for restricting control of a home entertainment device by a mobile device, the system comprising:
a storage device; and
processing circuitry configured to:
define a region for the mobile device;
determine whether the mobile device is within a predetermined range of the region;
in response to determining that the mobile device is within the predetermined range of the region, enable the mobile device to control a first function of the home entertainment equipment; and
in response to determining that the mobile device is outside of the predetermined range of the region, prevent the mobile device from controlling the first function of the home entertainment device and enable the mobile device to control a second function of the home entertainment device that is different from the first function.

12. The system of claim 1, wherein the region is within a certain distance from a specified location.

13. The system of claim 1, wherein the region is within a range of a given wireless communication network.

14. The system of claim 1, wherein the processing circuitry determines whether the mobile device is within the predetermined range of the region based on a GPS location determination for the mobile device.

15. The system of claim 1, wherein the processing circuitry determines whether the mobile device is within the predetermined range of the region based on the presence of a wireless link on a given wireless communication network.

16. The system of claim 1, wherein the processing circuitry prevents the mobile device from controlling a first function by disabling a mechanism for receiving a user command on the mobile device.

17. The system of claim 1, wherein the processing circuitry prevents the mobile device from controlling a first function by not performing an operation requested in a message related to the first function from the mobile device at the home entertainment device.

18. The system of claim 1, wherein the processing circuitry prevents the mobile device from controlling a first function by prompting a user at the home entertainment device whether a message related to the first function from the mobile device should be processed.

19. The system of claim 1, wherein the processing circuitry prevents the mobile device from controlling a first function by prompting a user of the mobile device to confirm a command of the user to control the first function.

20. The system of claim 1, wherein the processing circuitry prevents the mobile device from controlling a first function by providing the user with an option to perform an alternate function instead of the first function.

21. A system for restricting control of a home entertainment device by a mobile device, the system comprising:
means for defining a region for the mobile device;
means for determining whether the mobile device is within a predetermined range of the region;
means for, in response to determining that the mobile device is within the predetermined range of the region, enabling the mobile device to control a first function of the home entertainment equipment; and
means for, in response to determining that the mobile device is outside of the predetermined range of the region, preventing the mobile device from controlling the first function of the home entertainment device and enabling the mobile device to control a second function of the home entertainment device that is different from the first function.

22. The system of claim 1, wherein the region is within a certain distance from a specified location.

23. The system of claim 1, wherein the region is within a range of a given wireless communication network.

24. The system of claim 1, wherein the determining is based on a GPS location determination for the mobile device.

25. The system of claim 1, wherein the means for determining determines based on the presence of a wireless link on a given wireless communication network.

26. The system of claim 1, wherein the means for preventing the mobile device from controlling a first function disables a mechanism for receiving a user command on the mobile device.

27. The system of claim 1, wherein the means for preventing the mobile device from controlling a first function does not perform an operation requested in a message related to the first function from the mobile device at the home entertainment device.

28. The system of claim 1, wherein the means for preventing the mobile device from controlling a first function prompts a user at the home entertainment device whether a message related to the first function from the mobile device should be processed.

29. The system of claim 1, wherein the means for preventing the mobile device from controlling a first function prompts a user of the mobile device to confirm a command of the user to control the first function.

30. The system of claim 1, wherein the means for preventing the mobile device from controlling a first function provides the user with an option to perform an alternate function instead of the first function.
